(19) United States
(12) Patent Application Publication
(10) Pub. No.: US 2017/0305054 A1
(43) Pub. Date: Oct. 26, 2017

(54) EXTRUSION TOOLING AND PROCESS FOR BIODEGRADABLE COMPONENT

(71) Applicant: Joseph Wycech, Grosse Pointe Shores, MI (US)

(72) Inventor: Joseph Wycech, Grosse Pointe Shores, MI (US)

(21) Appl. No.: 15/647,816

(22) Filed: Jul. 12, 2017

Related U.S. Application Data
(62) Division of application No. 14/667,728, filed on Mar. 25, 2015, now abandoned.
(60) Provisional application No. 61/933,902, filed on Jan. 31, 2014.

(51) Int. Cl. B29C 47/00; B29C 47/86; B29C 47/20; B29C 47/08; B29C 47/92

(52) U.S. Cl. CPC B29C 47/0064; B29C 47/862; B29C 47/0066; B29C 47/20; B29C 47/92; B29C 47/0004; B29C 47/0023; B29C 47/0852; B29C 2947/92704; B29C 2947/92904; B29K 2995/006

(57) ABSTRACT

An example extrusion system includes a die including a circular cross-section disposed about an axis, and a plurality of slits disposed in the die and circumferentially spaced about a periphery of the die. Each of the plurality of slits has a generally rectangular cross-section. A ratio of a number of slits comprising the plurality of slits to a distance between the plurality of slits is between approximately 144:1 and 96:1. A method of forming a biodegradable component with an extrusion system is also disclosed.

### CROSS-REFERENCE TO RELATED APPLICATIONS

This application is a divisional of U.S. patent application Ser. No. 14/667,728, filed Mar. 25, 2015, which claims priority to U.S. Provisional Application No. 61/933,902 filed Jan. 31, 2014.

### BACKGROUND

This disclosure relates to biodegradable components and more particularly to the extrusion and forming of starch-based biodegradable components, and tooling and processes therefor.

Polystyrene foam is known and used as a packaging material for shipping, household items, cars, and other areas of manufacture and transportation. For instance, polystyrene foam materials are used to prevent damage to manufactured items during transportation, as well as adding stability to packaging during the shipping process.

### BRIEF DESCRIPTION OF THE DRAWINGS

FIG. 1 is a perspective view of example sheets of biodegradable material.

FIG. 2 is a perspective view of an example die for extruding biodegradable material and associated holder.

FIG. 3 is a cross-sectional view of an extruded article using the die of FIG. 2.

FIG. 4 is a cross-sectional view of an example sheet formed from the extruded article of FIG. 3.

FIG. 5 is a cross-sectional view of an example workpiece formed of a plurality of sheets as shown in FIGS. 1 and 4.

### SUMMARY

An example extrusion system includes a die including a circular cross-section disposed about an axis, and a plurality of slits disposed in the die and circumferentially spaced about a periphery of the die. Each of the plurality of slits has a generally rectangular cross-section. A ratio of a number of slits comprising the plurality of slits to a distance between the plurality of slits is between approximately 144:1 and 96:1.

Another example extrusion system comprises a holder configured to hold a thermoformable biodegradable material, and a circular die disposed about an axis and attached to the holder, and a tool configured to force the biodegradable material through the die. The circular die has a plurality of slits circumferentially spaced about a periphery of the die, each of the plurality of slits having a generally rectangular cross-section configured to extrude a generally rectangular sheet of the thermoformable biodegradable material. A ratio of a number of slits comprising the plurality of slits to a distance between the plurality of slits is between approximately 144:1 and 96:1.

An example method of forming a biodegradable component using an extrusion system includes choosing a diameter of a die including a circular cross-section in response to a desired size of a desired extruded article, attaching the die to a holder, the die including a plurality of slits circumferentially spaced about a periphery of the die, each of the plurality of slits having a generally rectangular cross-section, wherein a ratio of a number of slits comprising the plurality of slits to a distance between the plurality of slits is between approximately 144:1 and 96:1, providing a thermoformable biodegradable material to the holder, and moving the thermoformable biodegradable material through the die such that the thermoformable biodegradable material expands after passing through the plurality of slits, and the thermoformable biodegradable material from adjacent ones of the plurality of slits contacts to form a tubular biodegradable component.

### DETAILED DESCRIPTION

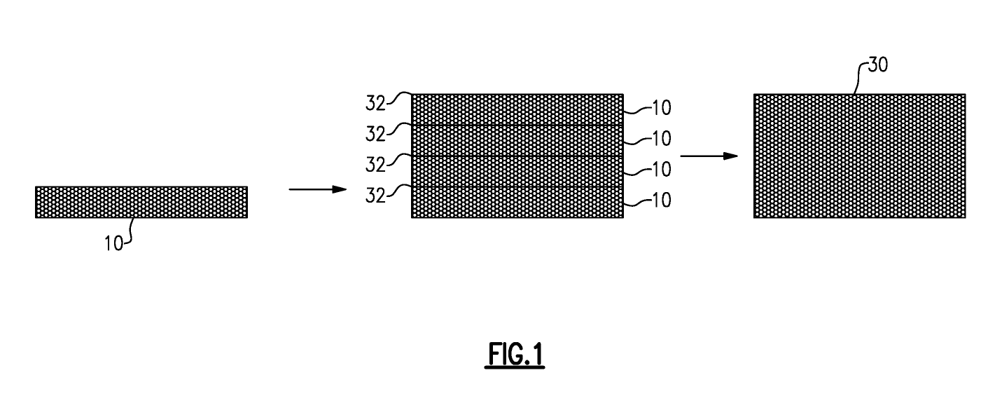

Referring to FIG. 1, a plurality of sheets 10 of a thermoformable, biodegradable material is shown. In one example, the each of the plurality of sheets 10 are formed of a starch-based biodegradable material. In a further example, the starch-based material is dissolvable in water. In another example, each of the plurality of sheets 10 are formed of a corn-based cellulosic material (“greencell”) or other cellulose based material. However, any biodegradable material may be used. ASTM International defines testing methods for determining whether a material is considered to be biodegradable.

Each of the plurality of sheets 10 are arranged such that they can be stacked to create a workpiece 30 of biodegradable material, which can be cut, formed, or otherwise manipulated to be used with tooling, as will be described in further detail below. Although the plurality of sheets 10 in this example includes four sheets 10, any number of sheets 10 may be used. In this example, each of the plurality sheets 10 has a generally rectangular profile. However, other profiles may be used depending on the workpiece 30 and/or component to be formed. Each of the plurality of sheets 10 is attached by an adhesive 32 disposed along contacting portions between the plurality of sheets 10. In one example, the adhesive 32 includes a starch-based adhesive or a dextrin-based adhesive. However, other adhesives may be used.

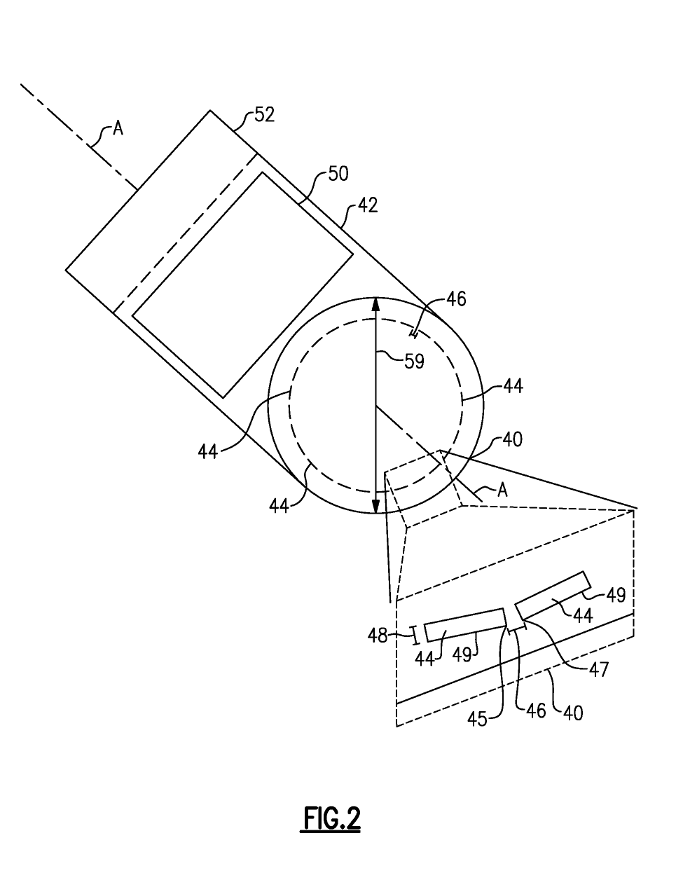

Referring to FIG. 2, a die 40 defined about an axis A is in communication with a holder 42 and is used to extrude a uniform sheet 10 of thermoformable biodegradable material. The die 40 defines a circular cross-section and includes a plurality of slits 44 extending through the die 40 along axis A. The plurality of slits 44 are disposed circumferentially entirely about axis A, and entirely around the die 40.

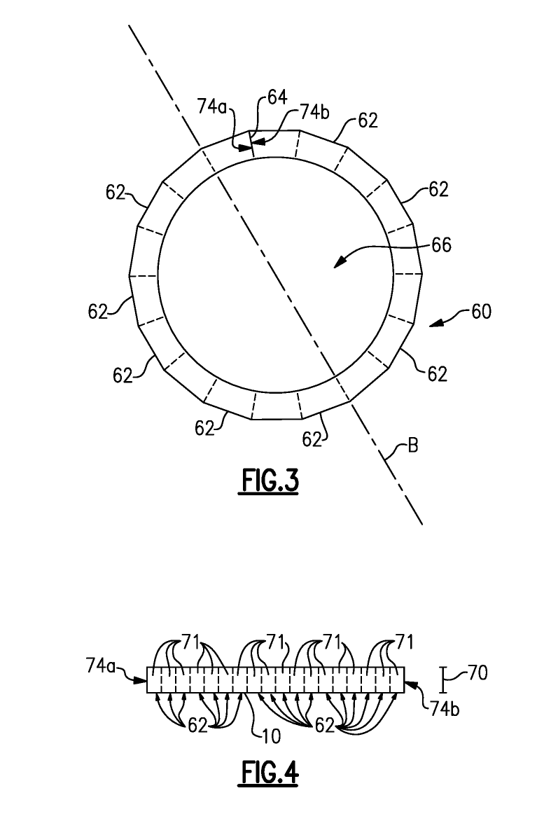

In this example, the plurality of slits 44 are equally circumferentially spaced a distance 46 apart about axis A and define a generally rectangular geometric profile. The distance 46 is defined between a first corner 45 and a second corner 47 of adjacent slits at an outer surface 49 of each slit. In this example, the distance 46 is between 0.125 inches and 0.1875 inches. Each of the plurality of slits 44 have a uniform cross sectional shape and a uniform radial thickness 48. In this example, the thickness 48 is between 0.060 inches and 0.120 inches. The plurality of slits 44 may each have a varying thickness 48 and be spaced a varying distance 46 apart in response to a desired extruded article (FIG. 3). The configuration of the die 40 and the plurality of slits 44 provides extrusion of a sheet 10 which has a uniform cross sectional area, thickness, and density, and is non-corrugated and non-convoluted.

The die 40 includes a diameter 59 between 8 inches and 14 inches. The diameter 59 is chosen in response to a desired size of an extruded article 60 (FIG. 3). In one example, the number of the plurality of slits 44 varies in response to the diameter 59.

In a further example, a ratio of the number of slits 44 to the distance 46 between slits 44 is between 144:1 and 96:1.

In one example, adjacent slits 44 of the plurality of slits 44 may be spaced non-uniform distances 46 apart and have non-uniform thicknesses 48 in response to a desired extruded article thickness.

In one example, the number of the plurality of slits 44 is determined based on the rate of extrusion through the plurality of slits 44 and the consistency of supply of thermoformable biodegradable material 50.

The die 40 is attached to the holder 42 (shown schematically) which holds a supply of thermoformable, biodegradable material 50 to be extruded. A tool 52 is in communication with the supply of thermoformable biodegradable material 50 and forces the thermoformable biodegradable material 50 towards die 40 and through the plurality of slits 44. In one example, the tool 52 is a screw.

In this example, the die 40 is heated during the extrusion process to between 300° F. and 600° F. In one example, the die 40 is heated during the extrusion process to 500 ° F. The heat and shaping provided by the die 40 as the thermoformable biodegradable material 50 is extruded through the plurality of slits 44 provides an extruded article (FIG. 3) having increased performance characteristics, as will be described in further detail below. In this example, the die 40 comprises one of a steel material or an aluminum material.

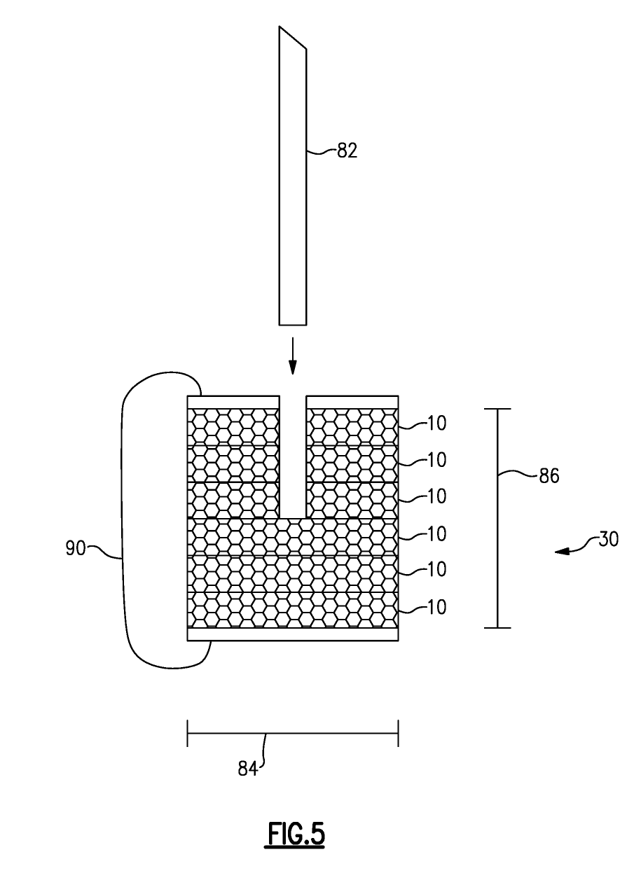

Referring to FIGS. 3 and 4, with continued reference to FIG. 2, after the thermoformable biodegradable material 50 is pushed through the plurality of slits 44, and heated and shaped by die 40, the thermoformable biodegradable material 50 is pushed out of die 40 along axis A in a direction opposite the tool 52 and holder 42. As the thermoformable biodegradable material 50 emerges from the plurality of slits 44, it expands such that the thermoformable biodegradable material 50 from adjacent slits 44 contact and join to form an extruded article 60, having a plurality of facets 62 having generally flat outer surfaces, and define a hollow center 66. The distance 46 between adjacent slits 44 is determined and implemented to provide spacing between adjacent slits 44 such that as the thermoformable biodegradable material 50 emerges and expands, thermoformable biodegradable material 50 from adjacent slits 44 is not so far apart as to not contact and join, but not so close so as to deform the extruded article 60.

After the extruded article 60 is formed via die 40, a second tool 64 (shown schematically) is used to cut the extruded article 60 along an axis B at a location 64. In one example, the second tool 64 is a knife. In this example, the extruded article 60 is cut once at the location 64 between adjacent facets. However, the extruded article 60 may be cut multiple times at different circumferential locations about the extruded article 60. Location 64 may also vary such that the extrude article 60 may be cut anywhere about the circumference of extruded article 60.

After the extruded article 60 is cut, it can be unrolled such that opposing ends 74a, 74b resulting from cutting the extruded article define ends of a sheet 10 of the plurality of sheets 10. As seen in FIG. 4, the facets 62 define segments 71 which are uniform and, now unrolled, form a single uniform sheet 10. The sheet 10 has a uniform thickness 70. In one example, the thickness is 70 is 0.5 inches. Other thicknesses 70 may be used to correspond to a desired thickness of each of the plurality of sheets 10 and in response to the desired thickness 48 of the plurality of slits 44 which is determined by corresponding product 82 (FIG. 5) the plurality of sheets 10 are to be used with.

The example die 40 with the plurality of slits 44 provides an isotropic sheet 10. That is, whereas a convoluted sheet includes toughs and peaks with inherent weaknesses in performance characteristics, the non-convoluted sheet 10 has no inherent physical weakness at a particular location along a length of the sheet 10 or within a cross-section of the sheet 10, and all surfaces of the sheet 10 may be utilized for the same functions. The example die 40 and plurality of slits 44 provide a sheet 10 that has increased performance characteristics compared to convoluted sheets, including increased load deflection, increased energy absorption, and increased durability. The configuration of the die 40 and the plurality of slits 44 provides extrusion of a sheet 10 which has a uniform cross sectional area, thickness, and density throughout the entire sheet 10 along axis B, and is non-corrugated and non-convoluted.

As seen in FIG. 1, once each sheet 10 is extruded from die 40, the plurality of sheets 10 are stacked and attached to form workpiece 30. The use of die 40 with plurality of slits 44 increases efficiency by eliminating the step of compressing the workpiece 30, as would be done to close the air space around convolutions of convoluted sheets.

Referring to FIG. 5, with continued reference to FIGS. 1 and 4, an example workpiece 30 comprised of plurality of sheets 10 formed using die 40 is shown. The workpiece 30 has been further formed to include a cavity 80 sized to receive a product 82 to be transported. The plurality of sheets 10 has uniform thickness and density.

In this example, the workpiece 30 has a width 84 of 2.8750 inches and a height 86 of 3.0 inches. In another example, the workpiece 30 has a cross-sectional area of 8 inches². The configuration of the die 40 and the plurality of slits 44 provides extrusion of a sheet 10 which has a uniform cross sectional area, thickness, and density, and is non-convoluted reduces usage of thermoformable biodegradable material 50 to form workpiece 30 by 50% compared to convoluted sheets. Additionally, the improved performance characteristics of the workpiece 30 formed using the configuration of the die 40 and the plurality of slits 44 allows for a workpiece 30 having a smaller cross-sectional area compared to a workpiece of convoluted and compressed layers, while maintaining similar or improved performance characteristics.

In this example, cavity 80 may be formed using a heated tool (not shown) having a cross sectional profile corresponding to the cross sectional profile of the portion of product 82 to be inserted into cavity 80. In this example, the workpiece 30 has a protective layer 90 attached by an adhesive to opposing sides of the workpiece 30. The protective layer 90 comprises one of cardboard or paper. In one example, the product 82 is a glass component, or other automotive component of manufacture.

Although a preferred embodiment of this disclosure has been disclosed, a worker of ordinary skill in this art would recognize that certain modifications would come within the scope of this disclosure. For that reason, the following claims should be studied to determine the true scope and content of this disclosure.

What is claimed is:

1. A method of forming a biodegradable component using an extrusion system, comprising:
choosing a diameter of a die including a circular cross-section in response to a desired size of a desired extruded article;
attaching the die to a holder, the die including a plurality of slits circumferentially spaced about a periphery of the die, each of the plurality of slits having a generally rectangular cross-section, wherein a ratio of a number of slits comprising the plurality of slits to a distance between the plurality of slits is between approximately 144:1 and 96:1;
providing a thermoformable biodegradable material to the holder; and
moving the thermoformable biodegradable material through the die such that the thermoformable biodegradable material expands after passing through the plurality of slits, and the thermoformable biodegradable material from adjacent ones of the plurality of slits contacts to form a tubular biodegradable component.

2. The method of claim 1, further comprising heating the die to between approximately 300° F. and 600° F.

3. The method of claim 1, further comprising cutting the tubular biodegradable component subsequent to the moving step, wherein the cutting step is performed in a radial direction with respect to an axis of the tubular biodegradable component to provide a biodegradable sheet, and unrolling the biodegradable sheet.

4. The method of claim 3, wherein the biodegradable sheet is a first biodegradable sheet, and further comprising stacking the first biodegradable sheet onto a second biodegradable sheet and attaching the first biodegradable sheet to the second biodegradable sheet subsequent the stacking step, and wherein the stacked first biodegradable sheet and the second biodegradable sheet comprise a workpiece.

5. The method of claim 4, wherein the workpiece includes an additional plurality of biodegradable sheets, the workpiece comprising a width of 2.8750 inches and a height of 3.0 inches.

6. The method of claim 4, wherein the workpiece includes a protective layer attached by an adhesive to a first side and an opposing second side.

7. The method of claim 1, further comprising determining a rate of extrusion of the thermoformable biodegradable material through the plurality of slits and determining a number of the plurality of slits in response to the rate of extrusion.

8. The method of claim 1, wherein the moving step creates an isotropic biodegradable sheet.

9. The method of claim 1, wherein the thermoformable biodegradable material is one of a starch-based and a cellulose-based material and the die comprises one of a steel material or an aluminum material.
